(19) United States
(12) Patent Application Publication
(10) Pub. No.: US 2007/0283142 A1
(43) Pub. Date: Dec. 6, 2007

(54) Multimode authentication using VOIP

(75) Inventors: David Milstein, Redmond, WA (US); Philip Andrew Chou, Bellevue, WA (US); Scott C. Forbes, Redmond, WA (US); Timothy M. Moore, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/447,470

(22) Filed: Jun. 5, 2006

(51) Int. Cl. H04L 9/00

(52) U.S. Cl. 713/155

(57) ABSTRACT

Generally described, multimode authentication over a VoIP communication channel is provided. A calling client and a called client may be authenticated for a communication channel establishment. When a calling client requests a call connection with a called client, the calling client is authenticated for the communication channel, based on exchanged contextual information between the calling client and the called client. Likewise, the called client is authenticated for the communication channel by the calling client. Upon authentication, a communication channel is established, over which the calling client and the called client are allowed to exchange more contextual and voice/multimedia information. During a conversation, when a secured service is desired by any of the clients, a series of authentication processes can be performed to grant access to the secured service over the communication channel without loss of the communication channel connection.

### BACKGROUND

Generally described, an Internet telephony system provides an opportunity for users to have a call connection with enhanced calling features compared to a conventional Public Switched Telephone Network (PSTN) based telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of communications, ability to establish and control multimedia communication, and the like. VoIP technology will likely continue to gain favor because of its ability to provide enhanced calling features and advanced services which the traditional telephony technology has not been able to provide. Some advanced services are provided by various individual information services or transaction systems on the Internet, which require different security requirements from each other. In such a multi-tier service environment, users may be authenticated multiple times to have such services, depending on the security requirements. However, current VoIP approaches do not provide a method and system to authenticate VoIP clients for granting access in a multi-tier service environment while VoIP clients are engaging a conversation over a VoIP communication channel.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to an aspect of the present invention, a method for multimode authenticating to verify clients identities over a digital voice communication channel is provided. A secured communication channel is established after mutual authentication of the clients. For example, while establishing the secured communication channel, authentication capabilities, such as proper authentication protocols, required information for authentication processes, etc., may be compared, negotiated, and agreed between clients. During a conversation over the secured communication channel, there may be monitoring for an event which may trigger a new authentication process. Such an event may be associated with a request for a secured service which requires some type of authentication. For example, a client may have authority or delegation from an authorized party to grant another client access to the requested secured service. Upon detecting an authentication trigger event, more contextual information relating to authentication may be obtained and processed. The client authenticates another client for the secured service and, as a result, another client is granted access to the secured service.

According to another aspect of the present invention, a method is provided for authenticating a right to access a communication channel between an authenticator client and an authenticatee client. A request to access the communication channel may be received from the authenticatee client. The authenticatee client may be authenticated based on the contextual information including authentication information (e.g., contextual information relating to authentication) of the authenticatee client. Upon authentication, the authenticatee client is granted access to the communication channel. The authenticatee client may be authenticated numerous times whenever the authenticatee requests a secured service for which the authenticator has authority or delegation to grant access to the secured service. In order to authenticate, the additional contextual information such as biometric information (e.g., a voice template) of a user of the authenticatee client, authentication protocol information relating to the particular service, login-password information, digital signature information, etc., will be obtained and utilized for the authentication process.

In yet another aspect of the present invention, a computer-readable medium having computer-executable components for multi-tier authentication over a communication channel is provided. The computer-executable components may include a communication component and a processing component. The communication component receives at least one request for access to a secured service. The processing component determines authentication of at least one request and subsequently grants access to the secured service upon authentication.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a VoIP environment for establishing a conversation channel between various clients in accordance with an aspect of the present invention;

FIG. 2 is a block diagram illustrative of a VoIP client in accordance with an aspect of the present invention;

FIG. 3 is a block diagram illustrative of various components associated with a VoIP device in accordance with an aspect of the present invention;

FIG. 4 is a block diagram illustrative of the exchange of data between two VoIP clients over a conversation channel in accordance with an aspect of the present invention;

FIG. 5 is a block diagram of a data packet used over a communication channel established in the VoIP environment of FIG. 1;

FIG. 6 is a block diagram illustrating interactions between two VoIP clients for transferring contextual information defined by identified structured hierarchies in accordance with an aspect of the present invention;

FIGS. 7A and 7B are block diagrams illustrating interactions between two clients for authenticating over a digital voice communication channel in accordance with an aspect of the present invention;

FIG. 8A is a block diagram illustrative of various attributes and classes of structural hierarchies corresponding to VoIP contextual information in accordance with an aspect of the present invention;

FIG. 8B is a block diagram of a call basic class, which is an exemplary subset of the structural hierarchies illustrated in FIG. 8A;

FIG. 8C is a block diagram of a call context class, which is an exemplary subset of the structural hierarchies illustrated in FIG. 8A;

FIG. 8D is a block diagram of a device type class, which is an exemplary subset of the structural hierarchies illustrated in FIG. 8A;

FIG. 8E is a block diagram of a VoIP clients class, which is an exemplary subset of the structural hierarchies illustrated in FIG. 8A;

FIG. 9 is a flow diagram illustrating a call set-up authentication routine for authenticating a digital voice communication channel establishment in accordance with an aspect of the present invention; and

FIG. 10 is a flow diagram illustrating an ongoing authentication routine for authenticating an authenticatee client upon receipt of a service request in accordance with a set of rules.

### DETAILED DESCRIPTION

Generally described, the present invention relates to a method and system for establishing and/or maintaining a secured communication channel in a multi-tier service environment. More specifically, the present invention relates to a method and system for performing a series of authentication processes to grant access to a secured service over the communication channel without loss of the communication channel connection. For example, the identity of a caller may be authenticated using multiple types of information which may be transmitted as part of a VoIP conversation. A VoIP conversation includes one or more data streams of information related to a conversation, such as contextual information and voice/multimedia information, exchanged over a conversation channel. In order to authenticate, contextual information relating to a particular authentication may be exchanged in conjunction with its corresponding “structured hierarchies.” “Structured hierarchies,” as used herein, are predefined organizational structures for arranging contextual information to be exchanged between two or more VoIP devices. For example, structured hierarchies may be eXtensible Markup Language (XML) namespaces. Although the present invention will be described with relation to illustrative structured hierarchies and an IP telephony environment, one skilled in the relevant art will appreciate that the disclosed embodiments are illustrative in nature and should not be construed as limiting.

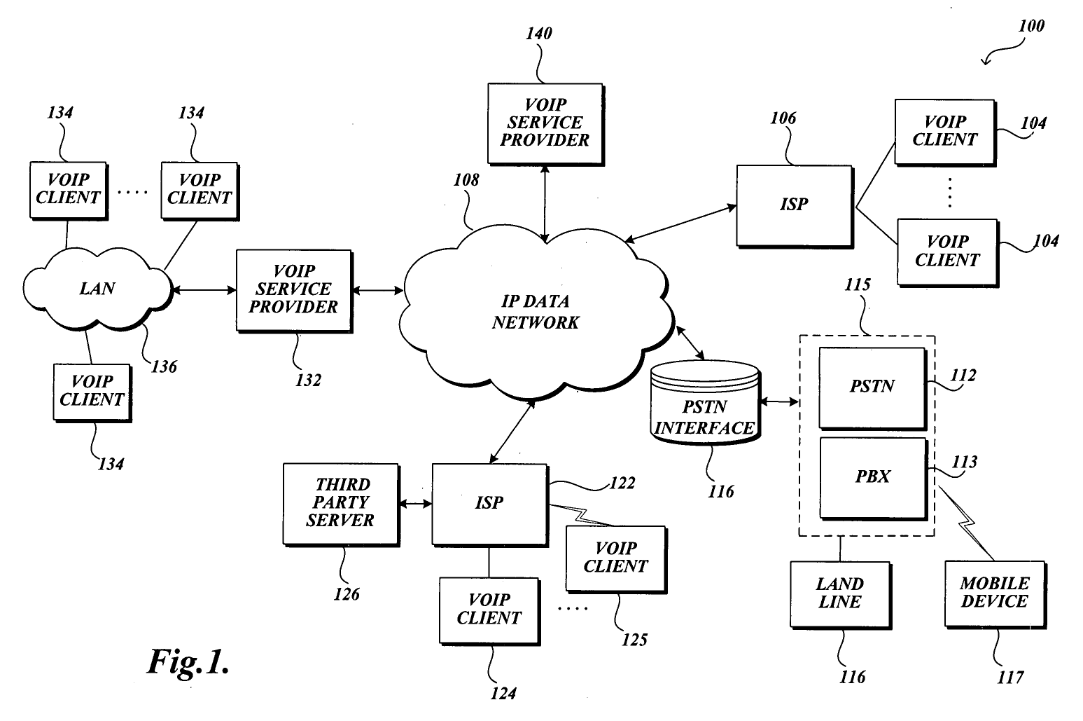

With reference to FIG. 1, a block diagram of an IP telephony environment 100 for providing IP telephone services between various “VoIP clients” is shown. A “VoIP client,” as used herein, refers to a particular contact point, such as an individual, an organization, a company, etc., one or more associated VoIP devices and a unique VoIP client identifier. For example, a single individual, five associated VoIP devices, and a unique VoIP client identifier can collectively make up a VoIP client. Similarly, a company including five hundred individuals and over one thousand associated VoIP devices may also be collectively referred to as a VoIP client and that VoIP client may be identified by a unique VoIP client identifier. Moreover, VoIP devices may be associated with multiple VoIP clients. For example, a computer (a VoIP device) located in a residence in which three different individuals live, each individual associated with separate VoIP clients, may be associated with each of the three VoIP clients. Regardless of the combination of devices, the unique VoIP client identifier may be used within a voice system to reach the contact point of the VoIP client.

Generally described, the IP telephony environment 100 may include an IP data network 108 such as the Internet, an intranet network, a wide area network (WAN), a local area network (LAN), and the like. The IP telephony environment 100 may further include VoIP service providers 126, 132 providing VoIP services to VoIP clients 124, 125, 134. A VoIP call conversation may be exchanged as a stream of data packets corresponding to voice information, media information, and/or contextual information. As will be discussed in greater detail below, the contextual information includes metadata (information of information) relating to the VoIP conversation, the devices being used in the conversation, the contact point of the connected VoIP clients, and/or individuals that are identified by the contact point (e.g., employees of a company).

The IP telephony environment 100 may also include third-party VoIP service providers 140. The VoIP service providers 126, 132, and 140 may provide various calling features, such as incoming call-filtering, text data, voice and media data integration, and the integrated data transmission as part of a VoIP call conversation. VoIP clients 104, 124, 125, and 134 may create, maintain, and provide information relating to predetermined priorities for incoming calls.

VoIP service providers 132 may be coupled to a private network such as a company LAN 136, providing IP telephone services (e.g., internal calls within the private network, external calls outside of the private network, and the like) and multimedia data services to several VoIP clients 134 communicatively connected to the company LAN 136. In one embodiment, one or more ISPs 106, 122 may be configured to provide Internet access to VoIP clients 104, 124, and 125 so that the VoIP clients 104, 124, and 125 can maintain conversation channels established over the Internet. The VoIP clients 104, 124, and 125 connected to the ISP 106, 122 may use wired and/or wireless communication lines.

Further, each VoIP client 104, 124, 125, and 134 may establish and maintain a secured communication channel via appropriate authentication. For example, VoIP client 124 and VoIP client 125 can be authenticated via a third-party authentication server 126 when a communication channel is established. In addition, during a conversation, multi-tier authentication may be implemented to provide secure services over the communication channel. Each secured service may require different authentication protocol, contextual information, and the like. Upon request of a secured service by either VoIP client 124 or VoIP client 125, an individual user, a system, and/or device of VoIP clients will be mutually authenticated. In a peer-to-peer environment, VoIP client 104, 124, 125, and 134 may authenticate a communication channel or a secured service generally utilizing offline third-party authentication server(s) 126. For example, some VoIP clients 104, 124, 125, and 134 may have agreed to use a particular third-party authentication server(s) for their peer-to-peer authentication. In this example, credentials, certificates, tokens, etc. (which is previously validated by the third-party authentication server) may be exchanged as part of contextual information over a communication channel.

Each VoIP client 104, 124, 125, and 134 can communicate with Plain Old Telephone Service (POTS) 115 communicatively connected to a PSTN 112 or PBX 113. A PSTN interface 114 such as a PSTN gateway may provide access between POTS/PSTN and the IP data network 108. Conventional voice devices, such as land line, may request a connection with the VoIP client and the appropriate VoIP device associated with the VoIP client will be used to establish a connection. In one example, an individual associated with the VoIP client may specify which devices are to be used in connecting a call based on a variety of conditions (e.g., connection based on the calling party, the time of day, etc.).

It is understood that the above-mentioned configuration in the environment 100 is merely exemplary. It will be appreciated by one of ordinary skill in the art that any suitable configurations with various VoIP entities can be part of the environment 100. For example, VoIP clients 134 coupled to LAN 136 may be able to communicate with other VoIP clients 104, 124, 125, and 134 with or without VoIP service providers 132 or an ISP 106, 122. Further, an ISP 106, 122 can also provide VoIP services to its client.

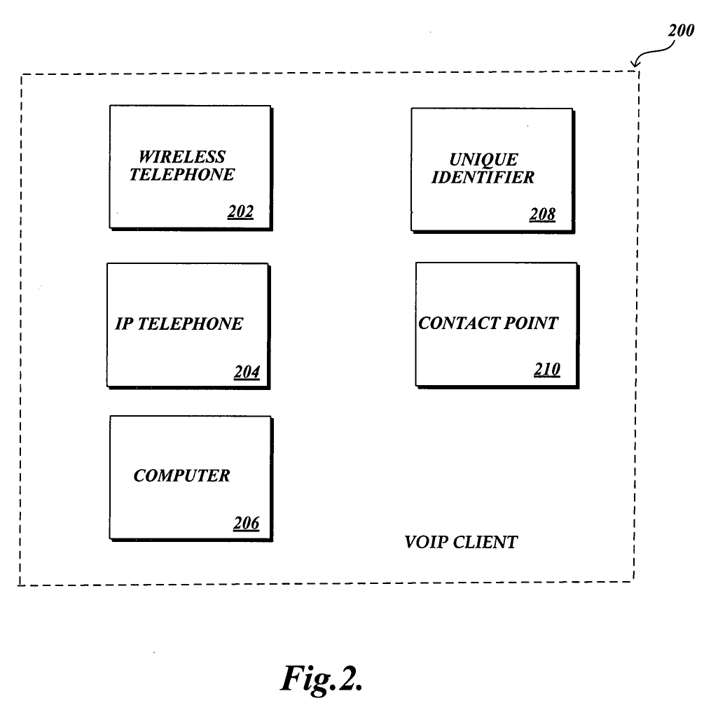

Referring now to FIG. 2, a block diagram illustrating an exemplary VoIP client 200 that includes several VoIP devices and a unique VoIP identifier, in accordance with an embodiment of the present invention, is shown. Each VoIP device 202, 204, 206 may include storage that is used to maintain voice messages, address books, client specified rules, priority information related to incoming calls, authentication protocol etc. Alternatively, or in addition thereto, a separate storage, maintained for example by a service provider, may be associated with the VoIP client and accessible by each VoIP device that contains information relating to the VoIP client. In an embodiment, any suitable VoIP device such as a wireless phone 202, an IP phone 204, or a computer 206 with proper VoIP applications may be part of the VoIP client 200. The VoIP client 200 also maintains one or more unique VoIP identifiers 208. The unique VoIP identifier(s) 208 may be constant or change over time. For example, the unique identifier(s) 208 may change with each call. The unique VoIP identifier is used to identify the client and to connect with the contact point 210 associated with the VoIP client. The unique VoIP identifier may be maintained on each VoIP device included in the VoIP client and/or maintained by a service provider that includes an association with each VoIP device included in the VoIP client. In the instance in which the unique VoIP identifier is maintained by a service provider, the service provider may include information about each associated VoIP device and knowledge as to which device(s) to connect for incoming communications. In an alternative embodiment, the VoIP client 200 may maintain multiple VoIP identifiers. In this embodiment, a unique VoIP identifier may be temporarily assigned to the VoIP client 200 for each call session.

The unique VoIP identifier may be used similarly to a telephone number in the PSTN. However, instead of dialing a typical telephone number to ring a specific PSTN device, such as a home phone, the unique VoIP identifier is used to reach a contact point, such as an individual or company, which is associated with the VoIP client. Based on the arrangement of the client, the appropriate device(s) will be connected to reach the contact point. In one embodiment, each VoIP device included in the VoIP client may also have its own physical address in the network or a unique device number. For example, if an individual makes a phone call to a POTS client using a personal computer (VoIP device), the VoIP client identification number in conjunction with an IP address of the personal computer will eventually be converted into a telephone number recognizable in PSTN.

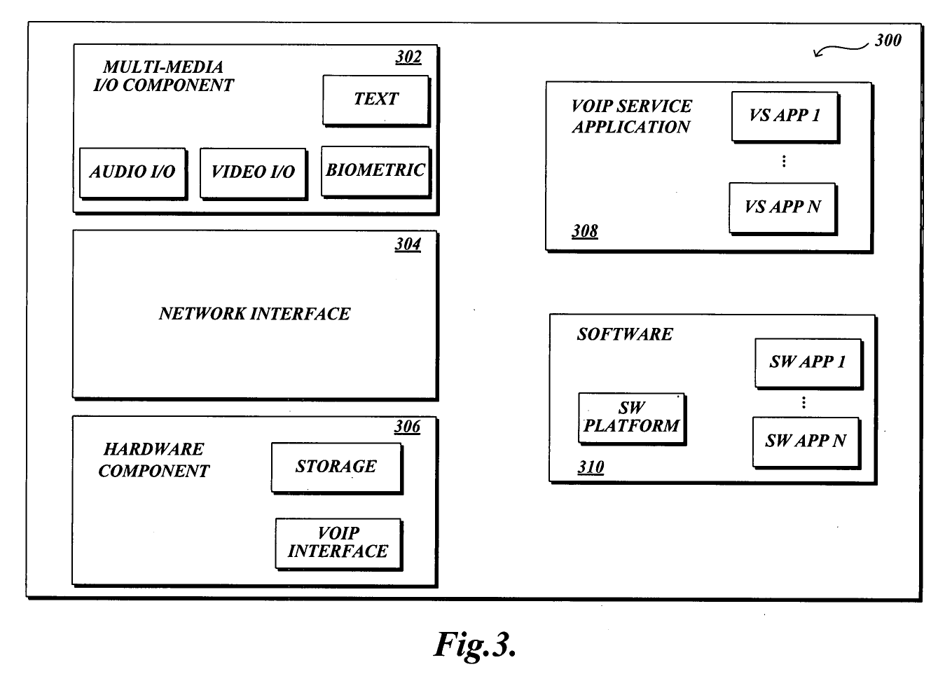

FIG. 3 is a block diagram of a VoIP device 300 that may be associated with one or more VoIP clients and used with embodiments of the present invention. It is to be noted that the VoIP device 300 is described as an example. It will be appreciated that any suitable device with various other components can be used with embodiments of the present invention. For utilizing VoIP services, the VoIP device 300 may include components suitable for receiving, transmitting, and processing various types of data packets. For example, the VoIP device 300 may include a multimedia input/output component 302 and a network interface component 304.

The multimedia input/output component 302 may be configured to input and/or output multimedia data (including audio, video, and the like), user biometrics, text, application file data, etc. The multimedia input/output component 302 may include any suitable user input/output components such as a microphone, a video camera, a display screen, a keyboard, user biometric recognition devices, and the like. The multimedia input/output component 302 may also receive and transmit multimedia data via the network interface component 304. The network interface component 304 may support interfaces such as Ethernet interfaces, frame relay interfaces, cable interfaces, DSL interfaces, token ring interfaces, radio frequency (air interfaces), and the like. The VoIP device 300 may comprise a hardware component 306 including permanent and/or removable storage such as read-only memory devices (ROM), random access memory (RAM), hard drives, optical drives, and the like. The storage may be configured to store program instructions for controlling the operation of an operating system and/or one or more applications and to store contextual information related to individuals (e.g., voice profiles, user biometrics information, etc.) associated with the VoIP client in which the device is included. In one embodiment, the hardware component 306 may include a VoIP interface card which allows a non-VoIP client device to transmit and receive a VoIP conversation.

The device 300 may further include a software application component 310 for the operation of the device 300 and a VoIP Service application component 308 for supporting various VoIP services. The VoIP service application component 308 may include applications such as data packet assembler/disassembler applications, a structured hierarchy parsing application, audio Coder/Decoder (CODEC), video CODEC and other suitable applications for providing VoIP services. The CODEC may use voice profiles to filter and improve incoming audio.

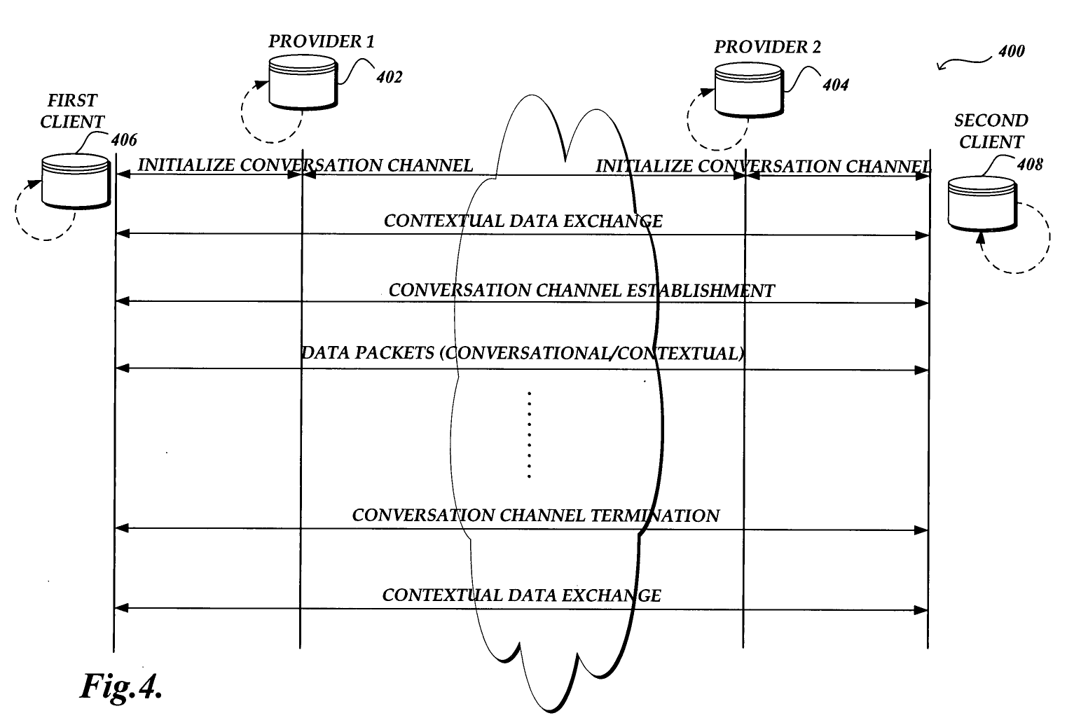

With reference to FIG. 4, a block diagram illustrative of a conversation flow 400 between VoIP devices of two different VoIP clients over a conversation channel in accordance with an embodiment of the present invention is shown. During a connection set-up phase, a VoIP device of a first VoIP client 406 requests to initiate a conversation channel (e.g., a call) with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 406. While this example utilizes two VoIP service providers and two VoIP clients, any number and combination of VoIP clients and/or service providers may be used with embodiments of the present invention. For example, only one service provider may be utilized in establishing the connection. In yet another example, communication between VoIP devices may be direct, utilizing public and private lines, thereby eliminating the need for a VoIP service provider. In a peer-to-peer context, communication between VoIP devices may also be direct without having any service providers involved.

A variety of protocols may be selected for use in exchanging information between VoIP clients, VoIP devices, and/or VoIP service providers. For example, when Session Initiation Protocol (SIP) is selected for a signaling protocol, session control information and messages will be exchanged over a SIP signaling path/channel and media streams will be exchanged over Real-Time Transport Protocol (RTP) path/channel. For the purpose of discussion, a communication channel, as used herein, generally refers to any type of data or signal exchange path/channel. Thus, it will be appreciated that, depending on the protocol, a connection set-up phase and a connection termination phase may require additional steps in the conversation flow 400.

For ease of explanation, consider an example in which the first VoIP client 406 and the second VoIP client 408 each include only one VoIP device. Accordingly, the discussion provided herein will refer to connection of the two VoIP devices. The individual using the device of the first VoIP client 406 may select or enter the unique identifier of the client that is to be called. Provider 1 402 receives the request from the device of the first VoIP client 408 and determines a terminating service provider (e.g., Provider 2 404 of the second VoIP client 408) based on the unique client identifier included in the request. The request is then forwarded to Provider 2 404. This call initiation will be forwarded to the device of the second VoIP client.

In an illustrative embodiment, as or before the devices of the first VoIP client 406 and the second VoIP client 408 begin to exchange data packets, contextual information may be exchanged. As will be discussed in greater detail below, the contextual information may be packetized in accordance with a predefined structure that is associated with the conversation. Any device associated with the first VoIP client 406, the service provider of the first VoIP client 406, or a different device/service provider may determine the structure based on the content of the contextual information. In one embodiment, the exchanged contextual information may include information relating to the calling VoIP client 406, the device, and the VoIP client 408 being called. For example, the contextual information sent from the called VoIP client 406 may include a priority list of incoming calls from various potential calling VoIP clients, including VoIP client 406.

Available media types, rules of the calling client, the client being called, and the like, may also be part of the contextual information that is exchanged during the connection set-up phase. The contextual information may be processed and collected by one of the devices of the first VoIP client 406, one of the devices of the second VoIP client 408, and/or by the VoIP service providers (e.g., Provider 1 402 and Provider 2 404), depending on the nature of the contextual information. In one embodiment, the VoIP service providers 402, 404 may add/delete some information to/from the client's contextual information before forwarding the contextual information.

In response to a request to initiate a conversation channel, the second VoIP client 408 may accept the request for establishing a conversation channel or execute other appropriate actions such as rejecting the request via Provider 2 404. The appropriate actions may be determined based on the obtained contextual information.

As will be discussed in greater detail, in one embodiment, the first VoIP client and the second VoIP client may exchange contextual information relating to authentication capabilities. If the first VoIP client and the second VoIP client have great disparity in their authentication capabilities such that the disparity cannot be resolved or acceptable for security reasons, the communication set-up session will be terminated. Otherwise, the first VoIP client and the second VoIP client will exchange contextual information required to authenticate a communication channel. Upon authentication, a conversation channel between the device of the first VoIP client 406 and a device of the second VoIP client 408 can then be established.

When a conversation channel is established, a device of the first VoIP client 406 and a device of the second VoIP client 408 start communicating with each other by exchanging data packets. As will be described in greater detail below, the data packets, including conversation data packets and contextual data packets, are communicated over the established conversation channel between the connected devices.

Conversation data packets carry data related to a conversation, for example, a voice data packet or multimedia data packet. Contextual data packets carry information relating to data other than the conversation data. During a conversation, contextual information relating multi-tier authentication between the first VoIP client 406 and the second VoIP client 408 may be exchanged. In one embodiment, a series of authentication processes may be performed over a communication channel while the communication channel connection is not interrupted or terminated by such authentication. As such, the first VoIP client 406 and the second VoIP client 408 can request, authenticate, decline, and/or provide a secured service without loss of the communication channel connection. Further, either the first VoIP client 406 or the second VoIP client 408 can request to terminate the conversation channel. Some contextual information may be exchanged between the first VoIP client 406 and the second VoIP client 408 after the termination.

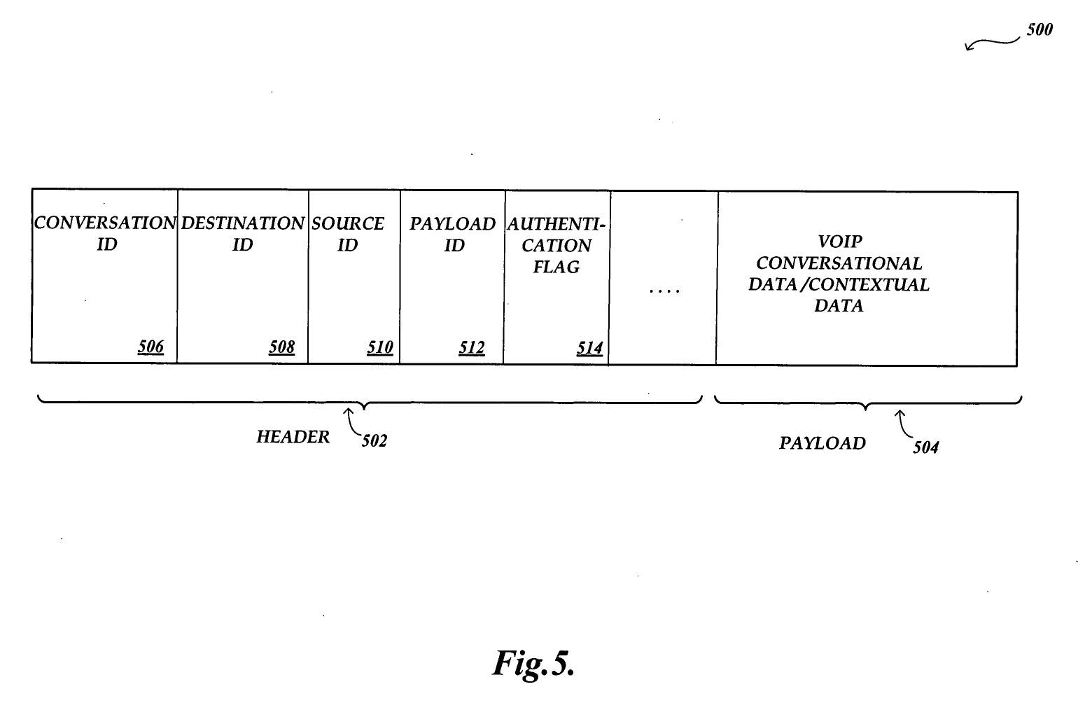

FIG. 5 is a block diagram of a data packet structure 500 used over a communication (conversation) channel in accordance with an embodiment of the present invention. The data packet structure 500 may be a data packet structure for an IP data packet suitable for being utilized to carry conversation data (e.g., voice, multimedia data, and the like) or contextual data (e.g., information relating to the VoIP services, and the like). However, any other suitable data structure can be utilized to carry conversation data or contextual data. The data packet structure 500 includes a header 502 and a payload 504. The header 502 may contain information necessary to deliver the corresponding data packet to a destination. Additionally, the header 502 may include information utilized in the process of a conversation. More specifically, such information may include conversation ID 506 for identifying a conversation (e.g., call), a Destination ID 508, such as a unique VoIP identifier of the client being called, a Source ID 510 (unique VoIP identifier of the calling client or device identifier), Payload ID 512 for identifying the type of payload (e.g., conversation or contextual), individual ID (not shown) for identifying the individual to which the conversation data is related, and the like. Further, the header 502 may include an Authentication Flag 514 to indicate that authentication information is included in contextual data of the payload 504. In one embodiment, the Authentication Flag 514 may be utilized to indicate what authentication protocol needs to be employed for the corresponding authentication information in the payload 504. In one embodiment, the header 502 may also contain information regarding Internet protocol versions, and payload length, among others. The payload 504 may include conversational or contextual data relating to an identified conversation. More specifically, authentication information may be piggybacked on the payload 504 and exchanged. In one embodiment, authentication information may be included as part of contextual information and identified by a recipient client of such contextual information. For example, user biometrics information (e.g., DNA information, finger print information, voice profile information, etc.) may be used to authenticate the identity of the sending client. Additionally, more than one type of information (e.g., the sending client's voice profile information in conjunction with finger print information) may be used to validate the identity of the sending client. As will be appreciated by one of ordinary skill in the art, additional headers may be used for upper layer headers such as a TCP header, a UDP header, and the like.

In one embodiment of the present invention, a structured hierarchy may be predefined for communicating contextual information over a VoIP conversation channel. The contextual information may include any information relating to VoIP clients, VoIP devices, conversation channel connections (e.g., call basics), conversation context (e.g., call context), and the like. More specifically, the contextual information may include client preference, client rules, client's location (e.g., user location, device location, etc.), biometrics information, the client's confidential information, VoIP device's functionality, VoIP service provider's information, media type, media parameters, calling number priority, keywords, information relating to application files, or the like. The contextual information may be processed and collected at each VoIP client and/or the VoIP service providers depending on the nature of the contextual data. In one aspect, the VoIP service providers may add, modify and/or delete the VoIP client's contextual data before forwarding the contextual information. For example, client's confidential information will be deleted by the VoIP service provider associated with that client unless the client authorizes such information to be transmitted. In some cases, a minimal amount of contextual information is transmitted outside of an intranet network.

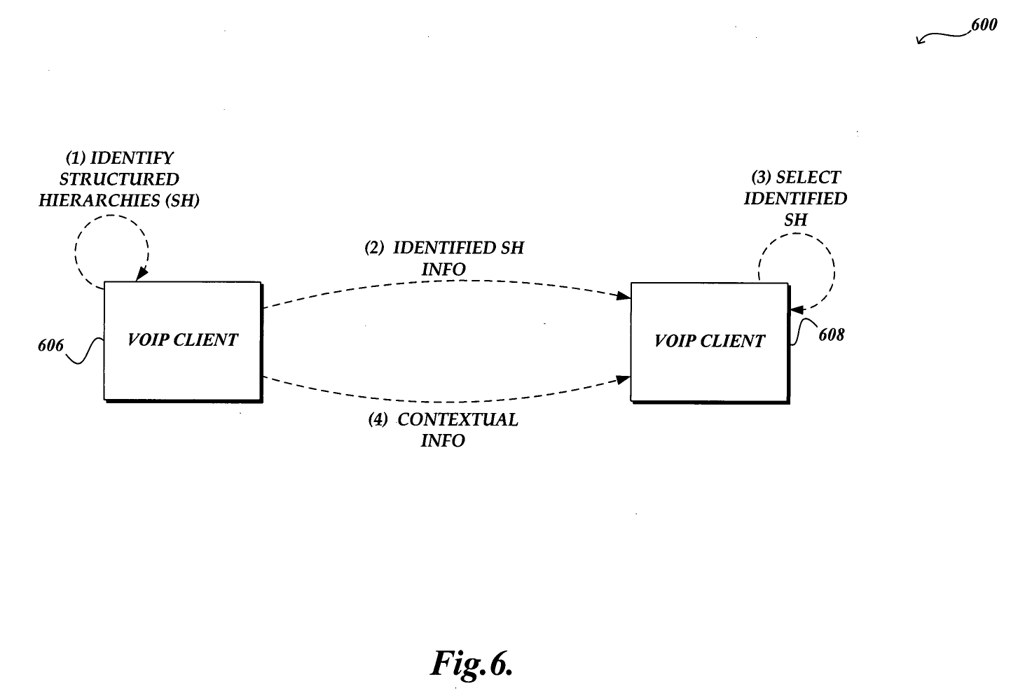

With reference to FIG. 6, a block diagram 600 illustrating interactions between two VoIP clients for transferring contextual information, in accordance with an embodiment of the present invention, is shown. As with FIG. 4, the example described herein will utilize the scenario in which each client only has one device associated therewith and the connection occurs between those two devices. In one embodiment, devices of VoIP Client 606 and VoIP Client 608 have established a VoIP conversation channel. It may be identified which structured hierarchies will be used to carry certain contextual information by VoIP Client 606. The information regarding the identified structured hierarchies may include information about which structured hierarchies are used to carry the contextual information, how to identify the structured hierarchy, and the like. Such information will be exchanged between VoIP Client 606 and VoIP Client 608 before the corresponding contextual information is exchanged. Upon receipt of the information identifying which structured hierarchy will be used to carry the contextual information, VoIP Client 608 looks up predefined structured hierarchies (e.g., XML namespace and the like) to select the identified structured hierarchies. In one embodiment, the predefined structured hierarchies can be globally stored and managed in a centralized location accessible from a group of VoIP clients. In this embodiment, a Uniform Resource Identifier (URI) address of the centralized location may be transmitted from VoIP Client 606 to VoIP Client 608.

In another embodiment, each VoIP client may have a set of predefined structured hierarchies stored in a local storage of any devices or a dedicated local storage which all devices can share. The predefined structured hierarchies may be declared and agreed upon between VoIP clients before contextual information is exchanged. In this manner, the need to provide the structure of the contextual data packets may be eliminated and thus the amount of transmitted data packets corresponding to the contextual data is reduced. Further, by employing the predefined structured hierarchies, data packets can be transmitted in a manner which is independent of hardware and/or software.

Upon retrieving the identified structured hierarchy, VoIP Client 608 is expecting to receive a data stream such that data packets corresponding to the data stream are defined according to the identified structured hierarchies. VoIP Client 606 can begin sending contextual information represented in accordance with the identified structured hierarchies. In one embodiment, VoIP Client 608 starts a data binding process with respect to the contextual information. For example, instances of the identified structured hierarchies may be constructed with the received contextual information.

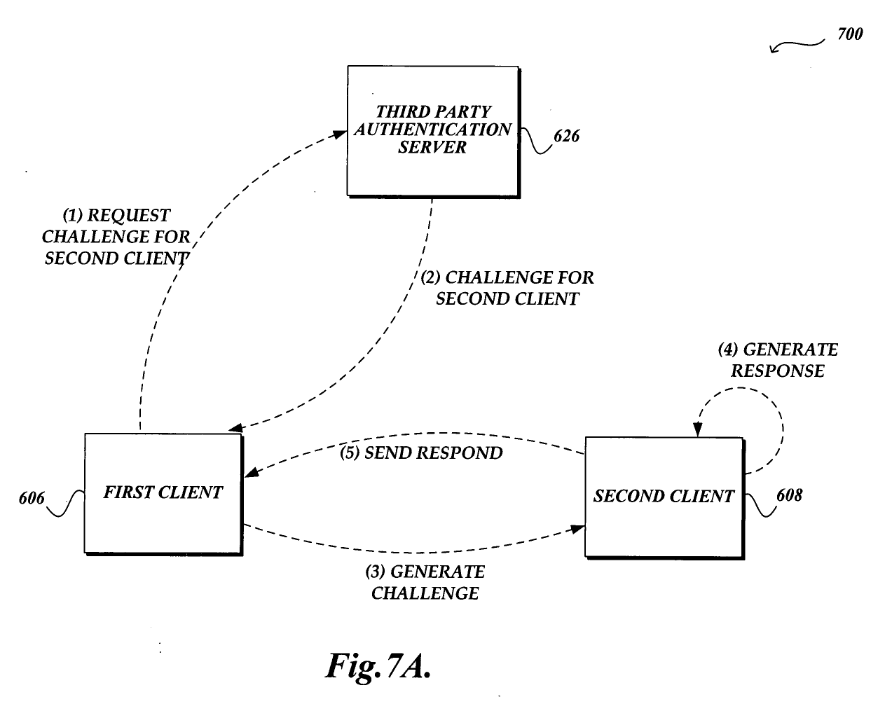

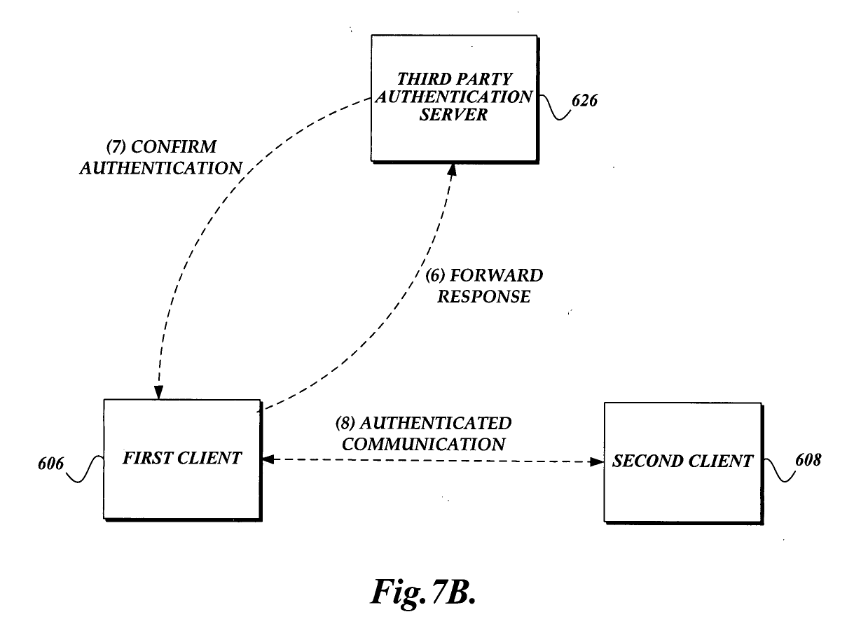

FIGS. 7A and 7B are block diagrams 700 illustrating interactions among several VoIP entities for authenticating a VoIP client over a conversation in accordance with an embodiment of the present invention. The VoIP entities may include VoIP clients, VoIP service providers, third-party service providers, and the like. While this example utilizes a third-party authentication server and two VoIP clients, any number and combination of VoIP clients, service providers and/or third-party authentication servers may be used with embodiments of the present invention. It is also contemplated that a series of different levels of authentication can be performed numerous times before, during, and/or after the conversation and contextual information corresponding to each level of authentication will be exchanged among VoIP entities. For discussion purposes, assume that First Client 606 and Second Client 608 have established a secured communication channel between devices of First Client 606 and Second Client 608.

Referring to FIG. 7A, during a conversation, First Client 606 may detect a triggering event, for example, a request for a secured service, which may start new authentication for Second Client 608. In one embodiment, First Client 606 and Second Client 608 may support a challenge-response authentication protocol in which an authenticator client presents a question (“challenge”) and an authenticatee client must provide a valid answer (“response”) to be authenticated. For the purpose of discussion, First Client 606 and Second Client 608 have agreed that a third-party authentication node 626 can provide authentication information (e.g., challenge, response, etc.) relating to Second Client 608 so that First Client does not have to be aware of private security information relating to Second Client 608.

Upon detecting the triggering event, First Client 606 may request a challenge for Second Client 608 to the third-party authentication node 626. Subsequently, First Client 606 may receive information relating to the challenge from the third-party authentication node 626. Based on the received information, First Client 606 generates contextual information including the challenge and transmits the contextual information to Second Client 608 over a secured communication channel. As mentioned above, structured hierarchies corresponding to the contextual information are identified by First Client 606. Information regarding the identified structured hierarchy may be transmitted to Second Client 608. As will be discussed in greater detail below, the information regarding the identified structured hierarchy may include information about which structured hierarchies are used to carry the corresponding contextual information, how to identify the structured hierarchies, and the like. As such, the information regarding the identified structured hierarchies and the corresponding contextual information, including the challenge, are sent to Second Client 608. Upon receipt of the contextual information, Second Client 608 may identify a set of rules defining how to process the contextual information. The contextual information may be processed in accordance with the identified structured hierarchies. Second Client 608 may generate a response using the received challenge from the processed contextual information. In a particular embodiment, a hash function (e.g., Message Digest algorithm-5 (MD5), etc.) may be utilized to generate the response with private security information (e.g., password, etc.) in Second Client 608. Second Client 608 sends contextual information including the generated response to First Client 606.

Referring to FIG. 7B, First Client 606 may process the contextual information and forward the response recognized from the contextual information to the third-party authentication node 626. The third-party authentication node 626 may check the response against its own calculation of the expected value based on the challenge which was previously generated. The third-party authentication node 626 sends a confirmation (upon authentication) or a notification indicating failed authentication to First Client 606. First Client 606 may grant Second Client 608 access to the secured services.

In an alternative embodiment, First Client 606 and Second Client 608 may support a peer-to-peer authentication protocol, thereby eliminating a need to communicate with the third-party authentication node online. In this embodiment, a device of First Client 606 can authenticate a device of second Client 608. Generally, a digital certificate, credential information, or the like may be exchanged for authentication.

As discussed above, the information regarding the identified structured hierarchies corresponding to the contextual information may be received by Second Client 608. Upon receipt of the information regarding the identified structured hierarchies, Second Client 608 may look up predefined structured hierarchies to select the identified structured hierarchies for the contextual information. In one embodiment, the structured hierarchies may be defined by Extensible Markup Language (XML). However, it is to be appreciated that the structured hierarchies can be defined by any language suitable for implementing and maintaining extensible structured hierarchies. Generally described, XML is well known as a cross-platform, software and hardware independent tool for transmitting information. Further, XML maintains its data as a hierarchically structured tree of nodes, each node comprising a tag that may contain descriptive attributes. XML is also well known for its ability to allow extendable (i.e., vendor customizable) patterns that may be dictated by the underlying data being described without losing interoperability. Typically, an XML namespace URI is provided to uniquely identify a namespace. In some instances, the namespace may be used as a pointer to a centralized location containing default information (e.g., XML Schema) about the document type the XML is describing.

In an illustrative embodiment, VoIP client 606 may identify a XML namespace for contextual information. When multiple contexts are aggregated, appropriate XML namespaces can be declared as an attribute at the corresponding tags. It is to be understood that XML namespaces, attributes, and classes illustrated herein are provided merely as an example of structured hierarchies used in conjunction with various embodiments of the present invention. After VoIP client 608 receives the XML namespace information, the VoIP client 606 transmits a set of data packets containing contextual information defined in accordance with the identified XML namespace or namespaces to VoIP client 608. When a namespace is present at a tag, its child elements share the same namespace in pursuant to the XML scope rule defined by XML 1.0 specification. As such, VoIP client 608 and VoIP client 606 can transmit contextual information without including prefixes in all the child elements, thereby reducing the amount of data packets transmitted for the contextual information.

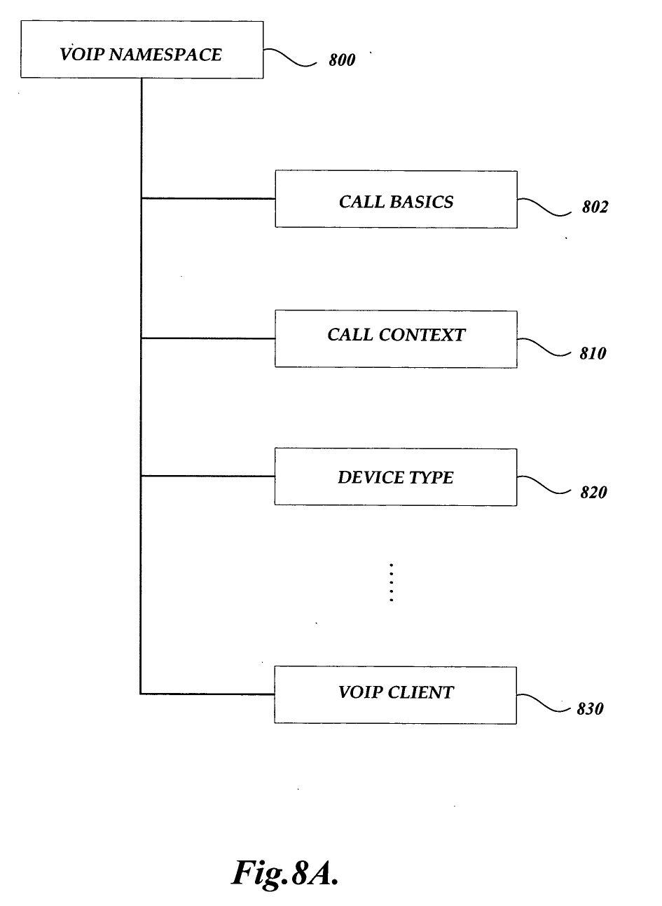

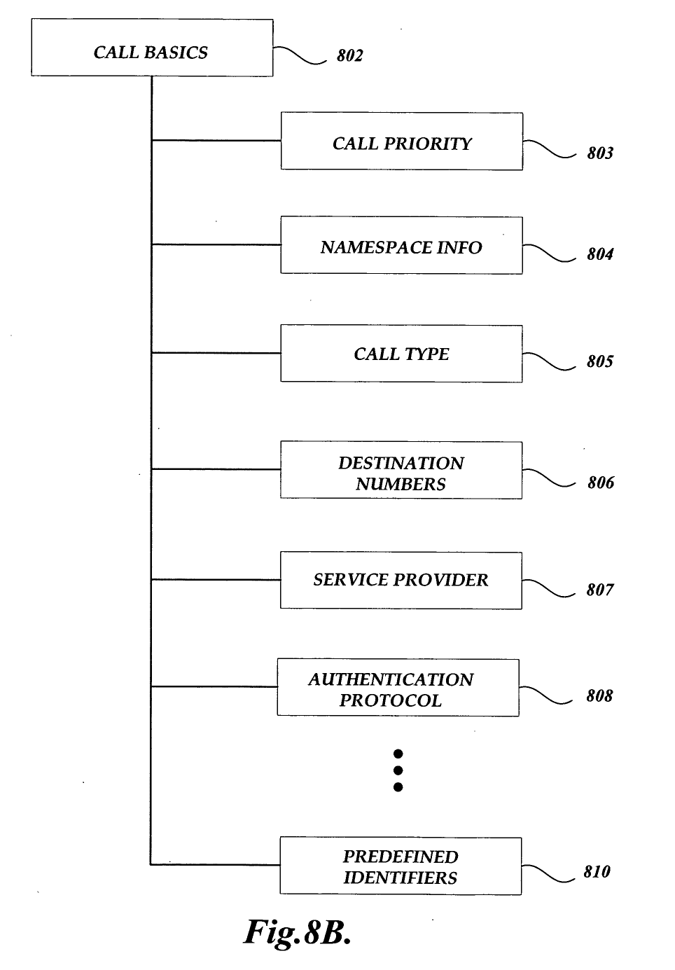

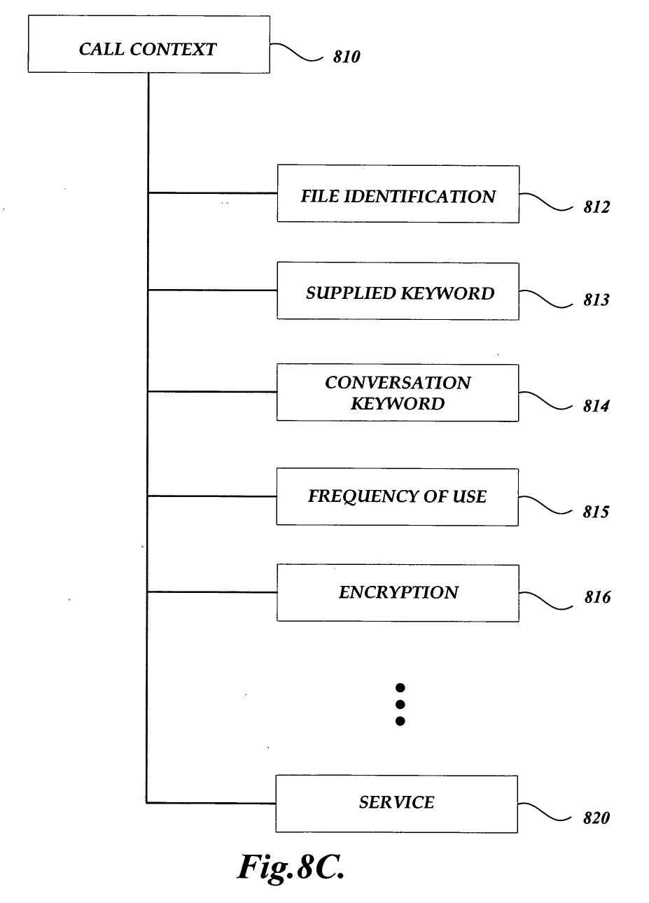

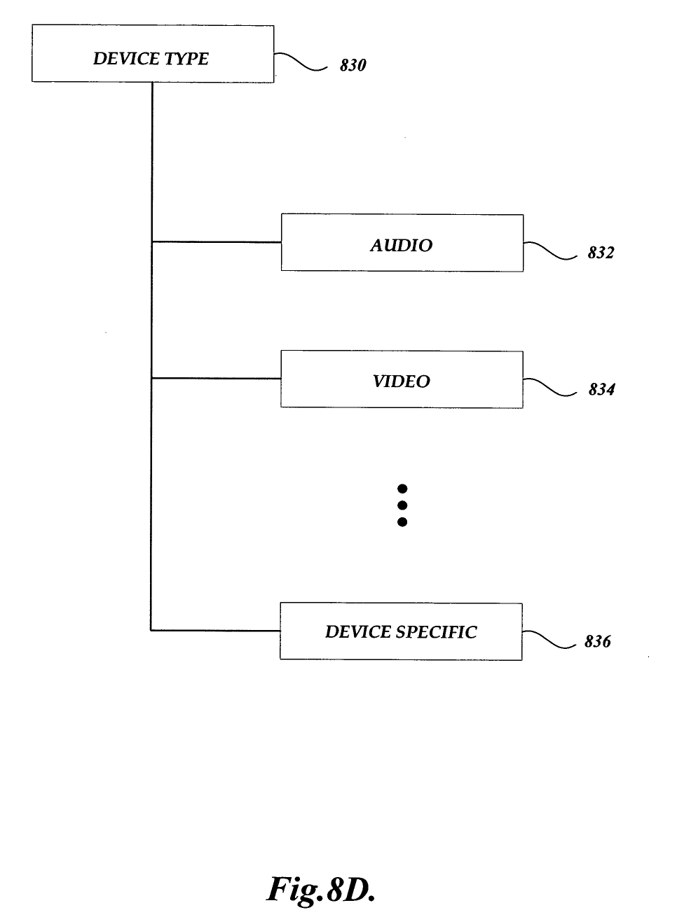

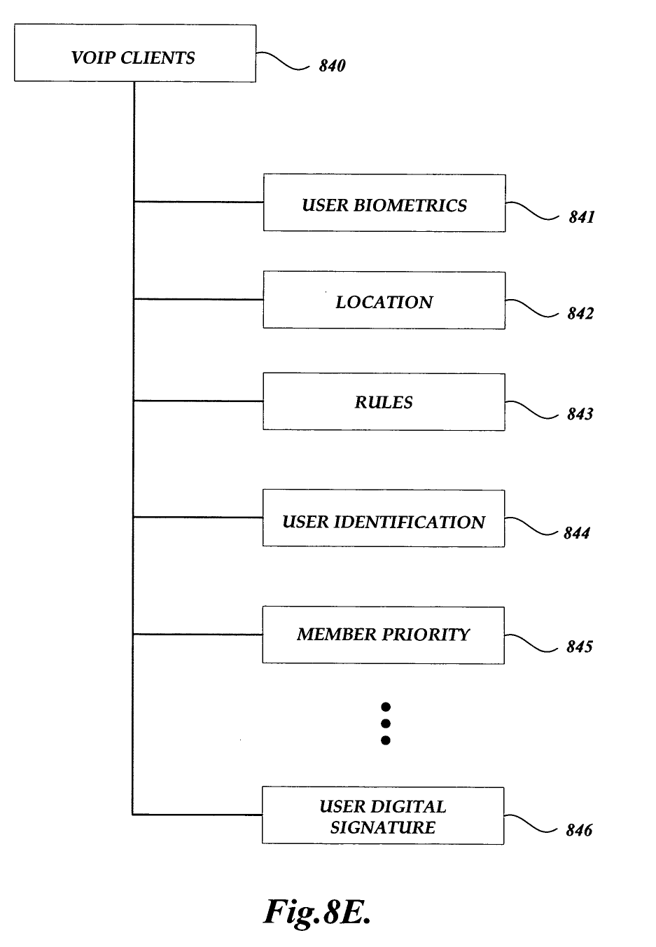

With reference to FIGS. 8A-8E, block diagrams illustrative of various classes and attributes of structured hierarchies corresponding to VoIP contextual information are shown. The VoIP contextual information exchanged between various VoIP entities (e.g., clients, service providers, etc.) may correspond to a VoIP namespace 800. In one embodiment, the VoIP namespace 800 is represented as a hierarchically structured tree of nodes, each node corresponding to a subclass which corresponds to a subset of VoIP contextual information. For example, a VoIP Namespace 800 may be defined as a hierarchically structured tree comprising a call basics class 802, a call contexts class 810, a device type class 820, a VoIP client class 830 and the like.

With reference to FIG. 8B, a block diagram of a call basics class 802 is shown. In an illustrative embodiment, call basics class 802 may correspond to a subset of VoIP contextual information relating to a conversation channel connection (e.g., a PSTN call connection, a VoIP call connection, and the like). The subset of the VoIP contextual information relating to a conversation channel connection may include originating numbers (e.g., a caller's client ID number), destination numbers (e.g., callees' client ID numbers or telephone numbers), call connection time, VoIP service provider related information, and/or ISP related information such as IP address, MAC address, namespace information, and the like. Additionally, the contextual information relating to a conversation channel connection may include call priority information (which defines the priority levels of the destination numbers), call type information, and the like. The call type information may indicate whether the conversation channel is established for an emergency communication, a broadcasting communication, a computer to computer communication, a computer to POTS device communication, and so forth. In one embodiment, the contextual information relating to a conversation channel connection may include authentication information such as an authentication protocol, third-party authentication server information, private and public key information, etc. Further, the contextual information relating to a conversation channel connection may include predefined identifiers that represent emotions, sounds (e.g., “ah,” “oops,” “wow,” etc.) and facial expressions in graphical symbols. In one embodiment, a call basics class 802 may be defined as a sub-tree structure of a VoIP namespace 800 that includes nodes such as call priority 803, namespace information 804, call type 805, destination numbers 806, service provider 807, authentication 808, predefined identifiers 810, and the like.

With reference to FIG. 8C, a block diagram of a call contexts class 810 is shown. In one embodiment, a subset of VoIP contextual information relating to conversation context may correspond to the call contexts class 810. The contextual information relating to conversation context may include information such as keywords supplied from a client, a service provider, a network, etc. The contextual information relating to conversation context may also include identified keywords from document file data, identified keywords from a conversation data packet (e.g., conversation keywords), file names for documents and/or multimedia files exchanged as part of the conversation, game related information (such as a game type, virtual proximity in a certain game), frequency of use (including frequency and duration of calls relating to a certain file, a certain subject, and a certain client), and file identification (such as a case number, a matter number, and the like relating to a conversation), among many others. In accordance with an illustrative embodiment, a call contexts class 810 may be defined as a sub-tree structure of a VoIP namespace 800 that includes nodes corresponding to file identification 812, supplied keyword 813, conversation keyword 814, frequency of use 815, subject of the conversation 816, and the like.

With reference to FIG. 8D, a block diagram of a device type class 820 is depicted. In one embodiment, a device type class.820 may correspond to a subset of VoIP contextual information relating to a VoIP client device used for the conversation channel connection. The subset of the VoIP contextual information relating to the VoIP client device may include audio related information that may be needed to process audio data generated by the VoIP client device. The audio related information may include information related to the device's audio functionality and capability, such as sampling rate, machine type, output/input type, microphone, digital signal processing (DSP) card information, and the like. The subset of the VoIP contextual information relating to the VoIP client device may include video related information that may be needed to process video data generated by the VoIP client device. The video related information may include resolution, refresh, type, and size of the video data, graphic card information, and the like. The contextual information relating to VoIP client devices may further include other device specific information such as a type of the computer system, processor information, network bandwidth, wireless/wired connection, portability of the computer system, processing settings of the computer system, and the like. In an illustrative embodiment, a device type class 820 may be defined as a sub tree structure of a VoIP namespace 800 that includes nodes corresponding to audio 822, video 824, device specific 826, and the like.

With reference to FIG. 8E, a block diagram of a VoIP client class 830 is depicted. In accordance with an illustrative embodiment, a VoIP client class 830 may correspond to a subset of contextual information relating to. VoIP clients. In one embodiment, the subset of the VoIP contextual information relating to the VoIP client may include voice profile information (e.g., a collection of information specifying the tonal and phonetic characteristics of an individual user), digital signature information, and biometric information. The biometric information can include user identification information (e.g., fingerprint) related to biometric authentication, user stress level, user mood, etc. Additionally, the subset of the VoIP contextual information relating to the VoIP client may include location information (including a client defined location, a VoIP defined location, a GPS/triangulation location, and a logical/virtual location of an individual user), assigned phone number, user contact information (such as name, address, company, and the like), rules defined by the client, a service provider, a network, etc., user preferences, digital rights management (DRM), a member rank of an individual user in an organization, priority associated with the member rank, and the like. The priority associated with the member rank may be used to assign priority to the client for a conference call. Further, in one embodiment, the subset of the VoIP contextual information relating to the VoIP client may include user identification information which will be used to authenticate a user. In FIG. 8E, a VoIP client class 830 may be defined as a sub tree structure of a VoIP namespace 800 that includes nodes corresponding to user biometrics 831, location 832, rules 833, user identification 834, member priority 835, user preference 836, and the like.

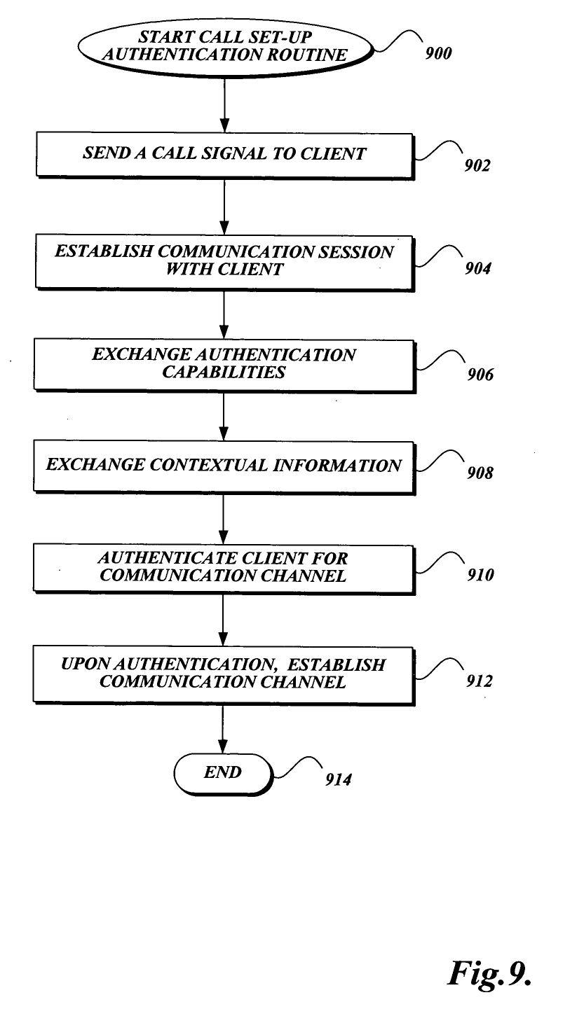

FIG. 9 is a flow diagram illustrating a call set-up authentication routine 900 for authenticating a digital voice communication channel establishment in accordance with an aspect of the present invention. In an illustrative embodiment, a sending client may desire to establish a digital voice communication channel connection with a recipient client. As with FIGS. 7A and 7B, a device of the sending client (a sending computing device) and a device of the recipient client (a recipient computing device) support a mutually agreed authentication protocol and are capable of establishing and maintaining a secure digital voice communication channel via the authentication protocol.

Beginning at block 902, a sending computing device sends a signal initiating a secure digital voice communication channel to a recipient computing device. At block 904, a communication session is first established to furtherance the call set up phase between the sending computing device and the recipient computing device. Over the communication session, the sending computing device and the recipient computing device exchange contextual information relating to a communication channel establishment. More specifically, contextual information relating to authentication capabilities may be exchanged as illustrated at block 906. Since each device and client may have different authentication capabilities and associated information, there may be some disparities in authentication capabilities between the recipient computing device and the sending computing device. In one embodiment, at block 908, both devices may try to resolve the disparity by exchanging relevant contextual information. When the disparities are not acceptable or negotiable, the call initiation signal will be rejected by either the recipient computing device or the sending computing device. For example, the recipient computing device may require certain authentication information such as user fingerprint information and login-password information from the sending computing device, which is not available in the sending computing device. In this example, the recipient computing device and the sending device may exchange the requirement for authentication, the scope of the available authentication information, and the like. The recipient computing device may negotiate with the sending computing device requesting other information. In one embodiment, the recipient computing device may ease its requirements if there has been a previous communication channel establishment with the sending client.

At block 910, the recipient client and/or the recipient computing device may be authenticated in accordance with a mutually agreed authentication protocol. An example of the authentication protocol includes Point-to-Point Protocol (PPP), Password Authentication Protocol (PAP), Challenge-Handshake Authentication Protocol (CHAP), Remote Authentication Dial In User Service (RADIUS) protocol, Terminal Access Controller Access Control System (TACACS) protocol, Lightweight Directory Access Protocol (LDAP), NT Domain authentication protocol, Unix password authentication protocol, Extended Authentication Protocol (EAP), and the like. As described above, in one embodiment, the recipient computing device may request a third-party authentication node (third-party authentication server) to authenticate the sending computing device for a secure digital voice communication channel establishment. For example, when a challenge-response authentication protocol is utilized, the recipient computing device may obtain a challenge for the sending computing device from the third-party authentication server and forward the response received from the sending computing device to the third-party authentication server. The third-party authentication server may verify the response against the challenge and subsequently send the result of the verification. If it is determined that the response corresponds to the challenge, the third-party authentication server will send a confirmation of authentication. Otherwise, the third-party authentication server will send a notification of authentication failure. Likewise, the recipient computing device may be authenticated for a secure digital voice communication channel. The recipient computing device may provide required authentication information to the sending computing device which will authenticate the recipient computing device.

At block 912, upon authentication based on the mutually agreed authentication protocol, a secure digital voice communication channel is established between the recipient computing device and the sending computing device. The sending computing device and the recipient computing device may start exchanging a conversation including contextual, voice, and/or media information over the secured digital voice communication channel. The routine 900 terminates at block 914.

It is to be understood that the embodiments explained in conjunction with the routine 900 are provided merely for example purposes. It is contemplated that the routine 900 can also be performed by the device of a sending client, a service provider, or a third-party service provider that is capable of receiving contextual information and has authority or delegation to authenticate a digital voice communication channel. It is contemplated that the authentication can be done via an online third-party authentication server, via exchange of credentials obtained from an offline third-party authentication server, or the like.

For the purpose of discussion, assume a scenario where an authenticatee client has two types of bank accounts, one for personal and one for business, with a particular bank. The authenticatee client has established a secure digital voice communication channel with an authenticator client (e.g., a bank teller, an Interactive Voice Response System (IVRS), etc., of the particular bank) for banking services on its personal accounts. During a conversation, the authenticatee client requests to see a previous bank statement belonging to its business account. However, the particular bank maintains different levels of authentication for personal and business accounts. For example, the bank may require different authentication protocols and different credentials for granting access to business accounts. Thus, the request to see the previous bank statement of its business account may trigger a new authentication process. In one embodiment, the authenticator client may reuse previously obtained authentication information or contextual information for this authentication process. In one embodiment, the authenticator client may request additional information (e.g., digital signature, user biometrics information, etc.) required to validate the authenticatee client to access the business account. The authenticatee client may collect the additional information accordingly and provide the collected information as part of the contextual information over the digital voice communication channel. The authenticator client validates the authenticatee client with the additional information and/or the previously obtained contextual information. Upon authentication, the authenticatee client can access its business account over the digital voice communication channel while the authenticatee client and the authenticator client continue conversation on the personal account. If the authentication fails, the authenticatee client may be notified about the failure and be asked for proper additional information. Upon receipt of the additional information, the authenticator may perform the authentication process one more time.

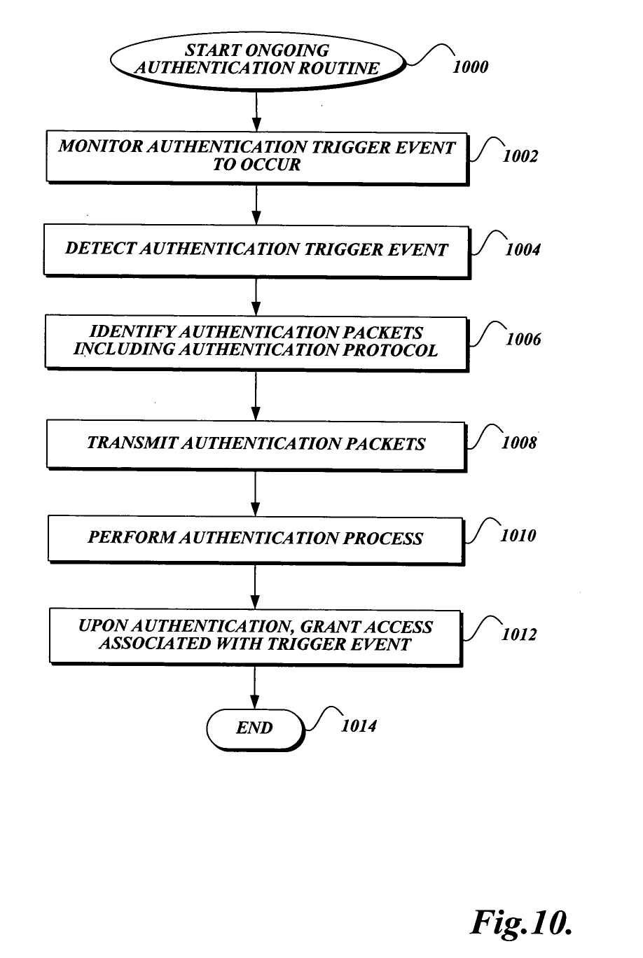

FIG. 10 is a flowchart illustrating an ongoing authentication routine 1000 for performing a series of different level of authentication over an existing digital voice communication channel in accordance with an embodiment of the present invention. As with FIG. 9, for the purpose of discussion, assume that a device of an authenticator client may have established a secured digital voice communication channel connection with a device of an authenticatee client.

Beginning at block 1002, the authenticator client may monitor for any events which may trigger a new authentication process while the devices of the authenticator client and the authenticatee client are exchanging data packets relating to a conversation. At block 1004, the authenticator client may detect at least one event (authenticator trigger event) which may trigger a new authentication process. In one embodiment, the authenticatee client may request a secured service which requires a different level of authentication from previous authentication over the digital voice communication channel. For example, the authenticatee client may request to access a secured database of the authenticator client to which a few individual users are allowed to access. In this example, the authenticator client may need extra information such as individual user's biometric information, credentials from a trusted third-party, or the like. In one embodiment, the authentication protocol employed for a particular service may require new authentication periodically. After a predetermined period, the existing authentication may expire, which will generate an event which triggers a new authentication process.

At block 1006, for each detected triggering event, its corresponding authentication protocol may be determined. Contextual information relating to authentication may be obtained. The contextual information may include necessary authentication information which the secured service may require for authentication. For example, the contextual information may include authentication protocol information, authentication capabilities, and the like. In an alternative embodiment, digital watermark in voice signals may be used as a vehicle to exchange authentication information between the authenticatee client and the authenticator client when the device of the authenticatee client is not capable of generating or transmitting contextual data packets. At block 1008, the obtained contextual information (authentication packets) may be transmitted to the authenticatee client to further the authentication process. Likewise, the authenticatee client may collect contextual information relating to a response to the authenticator client's contextual information and send the collected contextual information to the authenticator client. It is to be understood that based on the authentication protocol, different contextual information will be collected or generated. At block 1010, the authenticator performs authentication process. In one embodiment, the authenticator client may request a third-party authentication server to perform the authentication process for the secured service. For example, the authenticator client may request a third-party authentication server for confirming authentication of the authenticatee's response. The received authenticatee client's contextual information may be processed and forwarded to a third-party authentication server. At block 1012, upon authentication (or receiving a confirmation from the third-party authentication server) the authenticator client may grant the authenticatee access to the secured service. The routine 1000 terminates at block 1014.

It is to be understood that the embodiments explained in conjunction with the routine 1000 are provided merely for example purposes. It is contemplated that the routine 1000 can also be performed by the authenticatee client, a service provider, or a third-party service provider that is capable of receiving contextual information and has authority or delegation to authenticate a digital voice communication channel. It is further contemplated that the authentication can be done via an online third-party authentication server, via exchange of credentials obtained from an offline third-party authentication server, or the like.

In one embodiment, the authenticator client may be capable of performing a post-authentication process once the authenticatee client has been authenticated for at least one level of authentication but failed to be authenticated for another level of authentication. In this embodiment, contextual information relating to the authentication may be stored on the authenticator client for future authentication processes. Upon post-authentication, the authenticatee client may be granted access to the service at a later time. In another embodiment, the authenticator client may be capable of performing a post-authentication process on a batch of requests from several authenticatee clients.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for multimode authenticating to verify an identity of a client over a digital voice communication channel, the method comprising:
receiving a request for authentication from the client;
providing contextual information relating to authentication capabilities over the digital voice communication channel;
obtaining information relating to authentication of the client; and
authenticating the client based on the obtained information.

2. The method of claim 1, wherein the information relating to authentication of the client is obtained from the client as part of contextual information over the digital voice communication channel.

3. The method of claim 2, wherein authenticating the client includes generating digital certificate information and comparing the generated digital certificate information with the obtained information.

4. The method of claim 1, wherein the information relating to authentication of the client is obtained from an authorized party.

5. The method of claim 4, wherein the authorized party is an online third-party authentication node.

6. The method of claim 4, wherein the authorized party is an offline third-party authentication node.

7. The method of claim 4, wherein authenticating the client includes sending a confirmation request to the authorized party.

8. The method of claim 5 further comprising:
receiving a response to the confirmation request from the authorized party; and
determining whether the client is authorized for the digital voice communication channel based on the response from the authorized party.

9. The method of claim 1, further comprising:
upon authentication, allowing a secured communication channel to be established, wherein the client and another client exchange a digital voice conversation over the secured communication channel.

10. The method of claim 9, further comprising:
during the digital voice conversation over the secured communication channel, monitoring the secured communication channel for an authentication trigger event to occur; and
upon detecting that the authentication trigger event has occurred, performing ongoing authentication relating to the authentication trigger event.

11. The method of claim 10, wherein performing ongoing authentication includes obtaining additional information relating to the ongoing authentication;
transmitting the additional information to an authorized party; and
obtaining information relating to a confirmation of the additional information from the authorized party.

12. The method of claim 11 further comprising:
upon receipt of the information relating to a confirmation indicating a successful authentication, granting the client access associated with the authentication trigger event.

13. The method of claim 10, wherein the ongoing authentication includes multiple levels of authentication which requires several authentication processes with different sets of information.

14. A method for authenticating a right to access a communication channel between an authenticator client and an authenticatee client, the method comprising:
receiving a request to access the communication channel from the authenticatee client;
obtaining contextual information over a communication session channel, the contextual information relating to authentication of the authenticatee client;
authenticating the authenticatee client based on the contextual information; and
upon authentication, granting the authenticatee client access to the communication channel.

15. The method of claim 14, further comprising:
authenticating the authenticatee client based on additional contextual information if the authenticatee requests a secured service,
wherein the authenticator has authority or delegation rights to grant access to the secured service.

16. The method of claim 15, wherein the additional contextual information includes biometric information of a user of the authenticatee client.

17. The method of claim 16, wherein the additional contextual information includes authentication protocol information relating to the authenticatee client.

18. A computer-readable medium having computer-executable components for multi-tier authenticating a client over a communication channel, comprising:
a communication component for receiving at least one request for access to a secured service and for exchanging contextual information relating to authentication associated with the at least one request;
a processing component for determining authentication of the at least one request and for granting access to the secured service upon authentication, wherein the processing module component queries additional information from an authorization server in order to determine authentication associated with the at least one request; and
a generating component for generating part of the contextual information relating to authentication associated with the at least one request.

19. The computer-readable medium of claim 18, wherein the processing component uses the generated information and the additional information queried from the authorization server for determination of the authentication associated with the at least one request.

20. The computer-readable medium of claim 18, wherein the exchanged contextual information includes digital signature information.
